(19) United States
(12) Patent Application Publication
(10) Pub. No.: US 2014/0025921 A1
(43) Pub. Date: Jan. 23, 2014

(54) MEMORY CONTROL METHOD UTILIZING MAIN MEMORY FOR ADDRESS MAPPING AND RELATED MEMORY CONTROL CIRCUIT

(71) Applicant: JMicron Technology Corp., Hsin-Chu (TW)

(72) Inventors: Kuo-Hua Yuan, Hsinchu City (TW); Yung-Feng Chiu, Taichung City (TW); Hsiu-Che Chao, New Taipei City (TW)

(73) Assignee: JMicron Technology Corp., Hsin-Chu (TW)

(21) Appl. No.: 13/944,887

(22) Filed: Jul. 18, 2013

Related U.S. Application Data
(60) Provisional application No. 61/673,706, filed on Jul. 19, 2012.

(30) Foreign Application Priority Data
May 27, 2013 (TW) 102118632

(51) Int. Cl. G06F 12/10

(52) U.S. Cl. CPC G06F 12/1009
USPC 711/206

(57) ABSTRACT

A memory control method, including: writing a write-in data which has a logical address into a write-in cache buffer; generating a write-in address mapping table which maps the logical address of the data to a physical address of a main memory, and writing the write-in address mapping table into a cached data mapping table write buffer; writing the write-in data into the main memory according to the write-in address mapping table; and when an available storage space of the cached data mapping table write buffer is reduced to reach a predetermined threshold, writing the address mapping table in the cached data mapping table write buffer into the main memory, and storing a corresponding main memory write-in address mapping table into a global mapping table buffer.

### CROSS REFERENCE TO RELATED APPLICATIONS

This application claims the benefit of U.S. provisional application No. 61/673,706, filed on Jul. 19, 2012 and incorporated herein by reference.

### BACKGROUND OF THE INVENTION

1. Field of the Invention

The present disclosure relates generally to memory control, and more specifically, to a page-level memory control method and related circuit.

2. Description of the Prior Art

Recently, Solid State Drives (SSD) (e.g. NAND flash memories) have consolidated their positions in the storage media market, and have been widely employed on personal computers and a variety of portable devices. Compared with conventional hard disk drives, the SSDs have no requirements with respect to any mechanical components, and are therefore free from latency caused by disk spin for searching data. As a result, the SSD consumes less power compared with conventional hard disk. However, the performance of a flash memory maybe affected by data payloads. For instance, there is performance discrepancy between a random read/write of the SSD and continuous read/write of the SSD. The Flash Translation Layer (FTL) is responsible for the translation between a virtual address and a physical address. Thus, the design of the FTL is critical to the performance of the SSD.

In conventional designs, a random access memory (RAM) is applied to an FTL to buffer a mapping table arranged to record the translation between virtual addresses and physical addresses. However, the size of the embedded RAM in the FTL grows as the capacity of the flash memory grows. Especially, if a relatively small page-level unit is employed by the FTL for address mapping, the chip size and production cost will rapidly increase. Hence, to cut down the hardware requirement for the RAM in the SSD system while maintaining SSD's random read/write performance, there is a need for a novel page-level memory control method.

### SUMMARY OF THE INVENTION

Therefore, one of the objectives of the present invention is to provide a page-level memory control method and related circuit, to solve the aforementioned problem.

According to a first aspect of the present invention, an exemplary memory control method is disclosed. The exemplary memory control method includes: writing a write-in data which has a logical address into a write-in cache buffer; generating a write-in address mapping table which maps the logical address of the write-in data to a physical address of a main memory, and writing the write-in address mapping table into a cached data mapping table write buffer; writing the write-in data into the main memory according to the write-in address mapping table; and when an available storage space of the cached data mapping table write buffer is reduced to reach a predetermined threshold, writing the write-in address mapping table in the cached data mapping table write buffer into the main memory, and storing a corresponding main memory write-in address mapping table into a global mapping table buffer.

According to a second aspect of the present invention, an exemplary memory control method is disclosed. The exemplary memory control method includes: searching in a cached data mapping table write buffer for a read-out address mapping table which maps a logical address of a read-out data desired to be read to a physical address in a main memory; and when the read-out address mapping table is buffered in the cached data mapping table write buffer, reading the read-out data having the physical address from the main memory and writing the read-out data into a read-out cache buffer.

According to a third aspect of the present invention, an exemplary memory control circuit is disclosed. The exemplary memory control circuit includes a write-in cache buffer, a cached data mapping table write buffer, and a global mapping table buffer. The write-in cache buffer is arranged for buffering a write-in data having a logical address. The cached data mapping table write buffer is arranged for buffering a write-in address mapping table which maps the logical address of the write-in data to a physical address of a main memory. The global mapping table buffer is arranged for buffering a main memory write-in address mapping table corresponding to the write-in address mapping table of the cached data mapping table write buffer that is written into the main memory when an available storage space of the cached data mapping table write buffer is reduced to reach a predetermined threshold.

According to a fourth aspect of the present invention, an exemplary memory control circuit is disclosed. The exemplary memory control circuit includes a cached data mapping table read buffer, a read-out cache buffer, and a global mapping table buffer. The cached data mapping table read buffer is arranged for buffering a read-out address mapping table which maps a logical address of a read-out data desired to be read to a physical address of a main memory. The read-out cache buffer is arranged for buffering the read-out data having the physical address read from the main memory. The global mapping table buffer is arranged for obtaining the read-out address mapping table from the main memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a memory control method for writing data into a memory according to an embodiment of the present invention.

FIG. 2 is a flowchart illustrating a memory control method for reading data from a memory according to an embodiment of the present invention.

FIG. 3 is a memory control apparatus according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

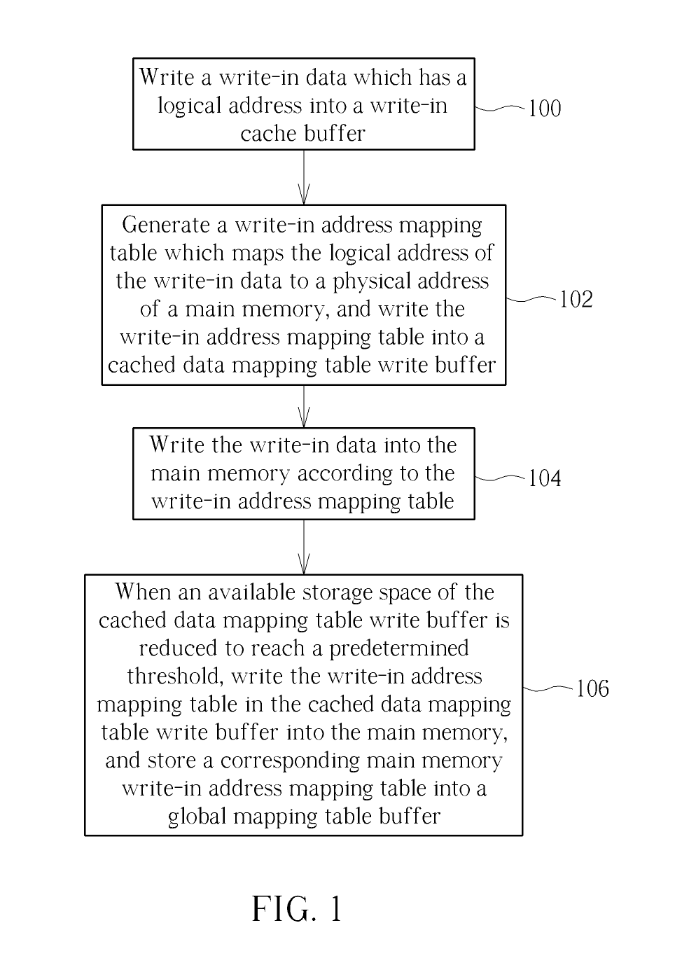

Please refer to FIG. 1, which is a flowchart illustrating a memory control method for writing data into a memory according to an embodiment of the present invention. Provided that substantially the same result is achieved, the steps of the flowchart shown in FIG. 1 need not be in the exact order shown and need not be contiguous; that is, other steps can be intermediate. Some steps in FIG. 1 may be omitted according to various types of embodiments or requirements. The method may be briefly summarized as follows:

Step 100: write a write-in data which has a logical address into a write-in cache buffer;

Step 102: generate a write-in address mapping table which maps the logical address of the write-in data to a physical address of a main memory, and write the write-in address mapping table into a cached data mapping table write buffer;

Step 104: write the write-in data into the main memory according to the write-in address mapping table; and

Step 106: when an available storage space of the cached data mapping table write buffer is reduced to reach a predetermined threshold, write the write-in address mapping table in the cached data mapping table write buffer into the main memory, and store a corresponding main memory write-in address mapping table into a global mapping table buffer.

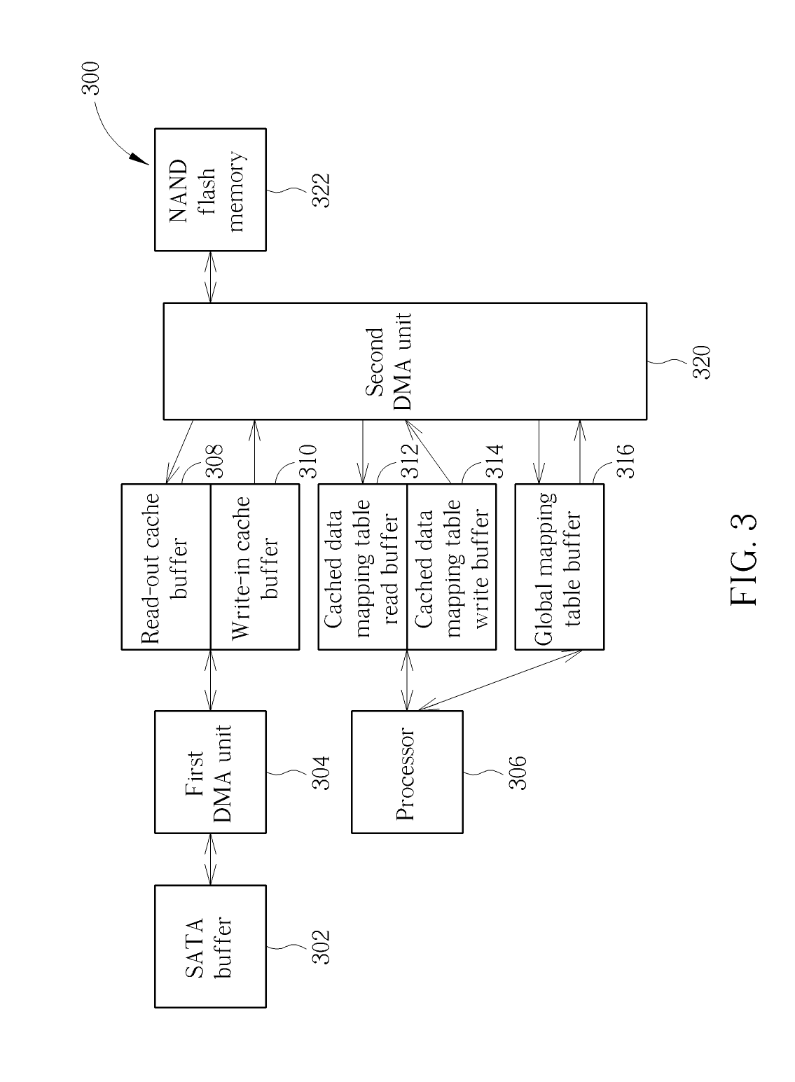

Regarding the memory control method for writing data into a memory as shown in FIG. 1, please refer to FIG. 3 together. FIG. 3 is a memory control apparatus 300 according to an embodiment of the present invention. The memory control apparatus 300 is used to translate the Logical Page Number (LPN) from an upper layer to the Physical Page Number (PPN) for an SSD. The memory control apparatus 300 includes a Serial Advanced Technology Attachment (SATA) buffer 302, a first Direct Memory Access (DMA) unit 304, a processor 306, a read-out cache buffer 308, a write-in cache buffer 310, a cached data mapping table read buffer 312, a cached data mapping table write buffer 314, a global mapping table buffer 316, a second DMA unit 320 and a NAND flash memory 322. When the upper layer requests to write a specific write-in data into the NAND flash memory 322, first of all, the specific write-in data is sequentially written into the write-in cache buffer 310 from the SATA buffer 302 via the first DMA unit 304, i.e. step 100. At the same time, the processor 306 generates a write-in address mapping table which maps a logical address of the specific write-in data to a physical address of the NAND flash memory 322, and writes the write-in address mapping table into a cached data mapping table write buffer 314, i.e. step 102. Please note that the memory control apparatus 300 of the present invention may process the data read/write and the address mapping operations based on a page-level unit. For instance, provided that each page of the NAND flash memory 322 has 8k bytes, no matter what size each unit from the upper SATA layer is, the first DMA unit 304 sequentially buffers inputted data in the write-in cache buffer 310, and does not write it into the NAND flash memory 322 via the second DMA unit 320 until the data accumulated fills at least one page, i.e. step 104. It should be noted that the memory control apparatus 300 of the present invention is utilized for controlling a SATA device terminal (i.e. the NAND flash memory 322), and connecting a SATA host terminal through the SATA buffer 302 and the first DMA unit 304. However, this is for illustrative purposes only, and is not meant to be a limitation of the present invention. In other embodiments of the present invention, the SATA buffer 302 and the first DMA unit 304 may be replaced with an USB 3.0 buffer and a DMA unit complying with USB 3.0 standard. In addition, the NAND flash memory 322 may also be changed to other types of SSDs. These alternative designs also belong to the scope of the present invention.

The size of the cached data mapping table write buffer 314 of the present invention is 64k bytes, wherein 4 bytes are arranged to act as the Physical Page Number (PPN); however, this is for illustrative purposes only, and is not meant to be a limitation of the present invention. If the available space of the cached data mapping table write buffer 314 is reduced to reach a write-in predetermined threshold T1, the write-in address mapping table in the cached data mapping table write buffer 314 will be grouped by a fixed number (e.g. 2048) of logically consecutive mappings in a page and then written into the NAND flash memory 322. Next, a corresponding main memory write-in address mapping table will be recorded and buffered in the global mapping table buffer 316 lastly, i.e. step 106. Please note that, in this embodiment, one-thousandth of the capacity of the NAND flash memory 322 (which is not a limitation of the present invention) is preserved for the write-in address mapping table. However, when writing the write-in address mapping table of the cached data mapping table write buffer 314 into the NAND flash memory 322, there is no need to write the write-in address mapping table into a specific region distinct from a normal region for normal data in the main memory. In other words, when the write-in address mapping table is stored into the NAND flash memory 322, the stored write-in address mapping table may be mixed with the stored normal data (i.e. the write-in address mapping table can be treated as a normal data). When the write-in address mapping table needs to be referenced, the corresponding write-in address mapping table can be found in accordance with the main memory write-in address mapping table buffered in the global mapping table buffer 316. In this way, it can prevent a certain region in the NAND flash memory 322 from being accessed frequently to have the number of access times higher than that of other regions, thus avoiding the wearing out of the lifetime of the certain region. In another aspect, in the conventional designs, all the write-in address mapping tables are required to be buffered in a buffer memory. However, along with the increasing size of the main memory, the size of the buffer memory tends to be increased to be couples or hundreds of MBytes. The present invention borrows a small part of the capacity from the NAND flash memory 322, which not only brings flexibility for hardware design but also dramatically cuts down the production cost.

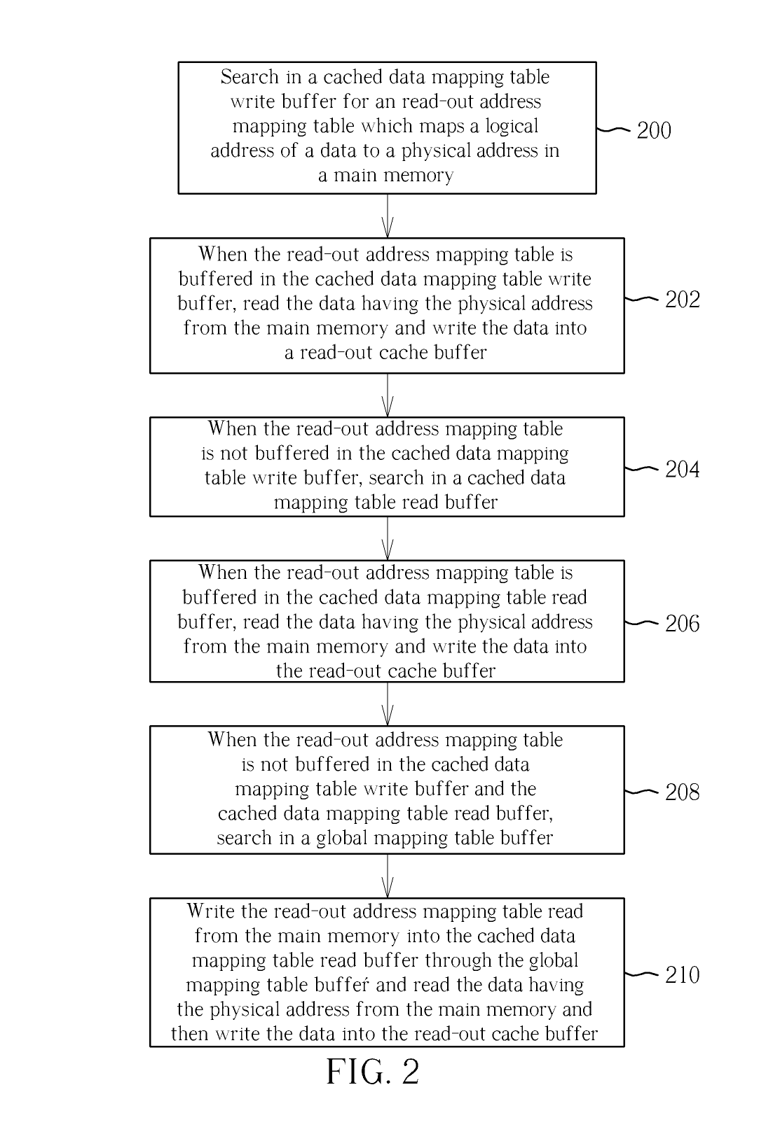

Please refer to FIG. 2, which is a flowchart illustrating a memory control method for reading data from a memory according to an embodiment of the present invention. Provided that substantially the same result is achieved, the steps of the flowchart shown in FIG. 2 need not be in the exact order shown and need not be contiguous; that is, other steps can be intermediate. Some steps in FIG. 2 may be omitted according to various types of embodiments or requirements. The method may be briefly summarized as follows:

Step 200: search in a cached data mapping table write buffer for an read-out address mapping table which maps a logical address of a data to a physical address in a main memory;

Step 202: when the read-out address mapping table is buffered in the cached data mapping table write buffer, read the data having the physical address from the main memory and write the data into a read-out cache buffer;

Step 204: when the read-out address mapping table is not buffered in the cached data mapping table write buffer, search in a cached data mapping table read buffer;

Step 206: when the read-out address mapping table is buffered in the cached data mapping table read buffer, read the data having the physical address from the main memory and write the data into the read-out cache buffer;

Step 208: when the read-out address mapping table is not buffered in the cached data mapping table write buffer and the cached data mapping table read buffer, search in a global mapping table buffer; and

Step 210: write the read-out address mapping table read from the main memory into the cached data mapping table read buffer through the global mapping table buffer; and read the data having the physical address from the main memory and then write the data into the read-out cache buffer.

Similarly, please refer to FIG. 2 in conjunction with FIG. 3. When the upper layer requests to read a specific read-out data from the NAND flash memory 322, the processor 306 will request to search in a cached data mapping table write buffer 314 for a read-out address mapping table which maps a logical address of a data to a physical address in a main memory, i.e. step 200. If the read-out address mapping table is buffered in the cached data mapping table write buffer 314, the second DMA unit 320 will read the data having the physical address from the NAND flash memory 322 and write the data into a read-out cache buffer 308, i.e. step 202. If the read-out address mapping table is not buffered in the cached data mapping table write buffer 314, then the cached data mapping table read buffer 312 will be searched, i.e. step 204. Next, if the read-out address mapping table is buffered in the cached data mapping table read buffer 312, the second DMA unit 320 will read the data having the physical address from the NAND flash memory 322 and write the data into the read-out cache buffer 308, i.e. step 206. However, if the read-out address mapping table is not buffered in the cached data mapping table write buffer 314 and the cached data mapping table read buffer 312, the global mapping table buffer 316 will be searched, i.e. step 208. Lastly, in step 210, the read-out address mapping table read from the NAND flash memory 322 is written into the cached data mapping table read buffer 312 through the global mapping table buffer 316; and the data having the physical address is read from the NAND flash memory 322 and is written into the read-out cache buffer 308. The size of the cached data mapping table read buffer 312 of the present invention is 16k bytes; however, this is for illustrative purposes only, and is not meant to be a limitation of the present invention. In a premise of not excessively affecting the random read/write operations, the present invention borrows a small part of the capacity from a main memory to replace the conventional buffers, which not only brings flexibility for hardware design but also dramatically cuts down the production cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory control method, comprising:
writing a write-in data which has a logical address into a write-in cache buffer;
generating a write-in address mapping table which maps the logical address of the write-in data to a physical address of a main memory, and writing the write-in address mapping table into a cached data mapping table write buffer;
writing the write-in data into the main memory according to the write-in address mapping table; and
when an available storage space of the cached data mapping table write buffer is reduced to reach a predetermined threshold, writing the write-in address mapping table in the cached data mapping table write buffer into the main memory, and storing a corresponding main memory write-in address mapping table into a global mapping table buffer.

2. The memory control method of claim 1, wherein the main memory is a NAND flash memory.

3. The memory control method of claim 1, wherein the memory control method is a page-level memory control method.

4. The memory control method of claim 1, wherein the step of writing the write-in address mapping table in the cached data mapping table write buffer into the main memory comprises:
writing the write-in address mapping table in the cached data mapping table write buffer into the main memory without storing the write-in address mapping table into a specific region distinct from a normal region in the main memory for storing a normal data.

5. A memory control method, comprising:
searching in a cached data mapping table write buffer for a read-out address mapping table which maps a logical address of a read-out data desired to be read to a physical address in a main memory; and
when the read-out address mapping table is buffered in the cached data mapping table write buffer, reading the read-out data having the physical address from the main memory and writing the read-out data into a read-out cache buffer.

6. The memory control method of claim 5, further comprising:
when the read-out address mapping table is not buffered in the cached data mapping table write buffer, searching in a cached data mapping table read buffer; and
when the read-out address mapping table is buffered in the cached data mapping table read buffer, reading the read-out data having the physical address from the main memory and writing the read-out data into the read-out cache buffer.

7. The memory control method of claim 5, further comprising:
when the read-out address mapping table is not buffered in the cached data mapping table write buffer and the cached data mapping table read buffer, searching in a global mapping table buffer; and
writing the read-out address mapping table read from the main memory into the cached data mapping table read buffer through the global mapping table buffer, and reading the read-out data having the physical address from the main memory and then writing the read-out data into the read-out cache buffer.

8. The memory control method of claim 5, wherein the main memory is a NAND flash memory.

9. The memory control method of claim 5, wherein the memory control method is a page-level memory control method.

10. A memory control circuit, comprising:
a write-in cache buffer, arranged for buffering a write-in data having a logical address;
a cached data mapping table write buffer, arranged for buffering a write-in address mapping table which maps the logical address of the write-in data to a physical address of a main memory; and
a global mapping table buffer, arranged for buffering a main memory write-in address mapping table corresponding to the write-in address mapping table in the cached data mapping table write buffer that is written into the main memory when an available storage space of the cached data mapping table write buffer is reduced to reach a predetermined threshold.

11. The memory control circuit of claim 10, wherein the memory control circuit is a page-level memory control circuit.

12. A memory control circuit, comprising:
a cached data mapping table read buffer, arranged for buffering a read-out address mapping table which maps a logical address of a read-out data desired to be read to a physical address of a main memory;
a read-out cache buffer, arranged for buffering the read-out data having the physical address that is read from the main memory; and
a global mapping table buffer, arranged for obtaining the read-out address mapping table from the main memory.

13. The memory control circuit of claim 12, wherein the memory control circuit is a page-level memory control circuit.
